(19) United States
(12) Patent Application Publication
(10) Pub. No.: US 2011/0271516 A1
(43) Pub. Date: Nov. 10, 2011

(54) Socket Adaptor Apparatus and Methods

(75) Inventor: Robin R. Slaton, Fort Collins, CO (US)

(73) Assignee: Swift Distribution, Inc. d/b/a Ultimate Support Systems, Torrance, CA (US)

(21) Appl. No.: 13/144,272

(22) PCT Filed: Jan. 14, 2010
(86) PCT No.: PCT/US2010/021073

§ 371 Date: Jul. 12, 2011

Related U.S. Application Data
(60) Provisional application No. 61/144,649, filed on Jan. 14, 2009.

(51) Int. Cl. F16B 21/07; B23P 11/00

(52) U.S. Cl. 29/525.03; 403/326; 403/328

(57) ABSTRACT

The inventive technology, in embodiments, may be described as a socket adaptor featuring automatic conformance to a tube (e.g., the inner surfaces of the end of a tube) upon the application of weight to the adaptor (e.g., to a plunger thereof), thereby allowing the secure connection of one tube to another tube in fast, effective manner.

### CROSS-REFERENCES TO RELATED APPLICATIONS

This international patent application claims priority to U.S. Provisional Application No. 61/144,649, filed 14 Jan. 2009, said provisional application incorporated herein in its entirety.

### TECHNICAL FIELD

The inventive technology disclosed herein relates to socket adaptors and guitar cases.

### BACKGROUND ART

Many applications require that two tubes be connected somehow such that the tubes are positionally fixed relative to each other during application of a weight directly from one of the tubes. At times, two tubes may be directly connected because their relative sizes allow for a corresponding ID with OD fit with one tube inside the other. At other times (particularly where no such corresponding ID with OD fit is possible), a socket adaptor may be used (perhaps it has a corresponding ID with OD fit with one tube and an adjusted (e.g., via a radially inwardly penetrating screw) fit with the other tube. However, other socket adaptors may allow for corresponding ID with OD fit with both tubes, or have adjusted fits with both tubes). Regardless, either a corresponding ID with OD fit, or some type of labor (e.g., screwing) requiring fit may be required. Corresponding ID with OD fit or course requires a properly sized adaptor, and avoiding a socket attachment that involves, e.g., a time intensive procedure such as screwing may require corresponding ID with OD fits on both ends of the adaptor. For each different combination of first tube size with second tube size, a different adaptor will be required, which can get expensive and time consuming and frustrating (especially where an adaptor for a unique combination is not at hand). Particular embodiments of the inventive technology seek to mitigate one or more of such problems.

It is of note that the goal of preferred embodiments of the socket adaptor apparatus is to automatically conform a portion of the socket adaptor to the inner diameter of a second tube (of a speaker mounting bracket, as but one example) that a first tube is to be fixed to (at least during application of the weighting force). Additional advantages relate to the easy and fast removal of the socket adaptor from the second tube upon removal of the weight force, and preclusion of the need for socket adaptors that require on-site screwing or other labor and time intensive procedures to secure one tube to another. Another advantage relates to the fact that in particular embodiments of the inventive technology, the greater the weight, the stronger the connection.

A distinct aspect of the inventive technology is a guitar case that one or more of the following features: paneling with holes, curved paneling, ribs, and/or inserts as herein described. Advantages include the provision of enhanced impact resistance and/or overall structure as compared with conventional technologies without increasing weight of the case to an unacceptable degree. Of course, additional advantages may be disclosed elsewhere in the application.

### DISCLOSURE OF INVENTION

The inventive technology, in embodiments, may be described as a socket adaptor featuring automatic conformance to a tube (e.g., the inner surfaces of the end of a tube) upon the application of weight to the adaptor (e.g., to a plunger thereof), thereby allowing the secure connection of one tube to another tube in fast, effective manner. Certain guitar case embodiments involve the use of a curved panel with holes (voids) so as to create a controlled flex pattern in order to controllably dissipate impact forces applied to the front of the guitar case. Ribs may be used to provide additional structure and impact resistance.

### BRIEF DESCRIPTION OF DRAWINGS

FIG. 1 shows various views of an embodiment of the inventive socket adaptor.

FIG. 2 shows a cutaway cross-sectional view of a 4 wedge embodiment of the inventive socket adaptor.

FIG. 3 shows a cutaway cross-sectional view of one portion of a 3 wedge embodiment of the inventive socket adaptor.

FIG. 4 shows one certain parts of an embodiment of the inventive socket adaptor (emphasizing that the central bar can have an orientation opposite that orientation shown in FIG. 3).

FIG. 5 shows a wedge viewed directly down its slot (on left) and a cross-sectional side view of such wedge.

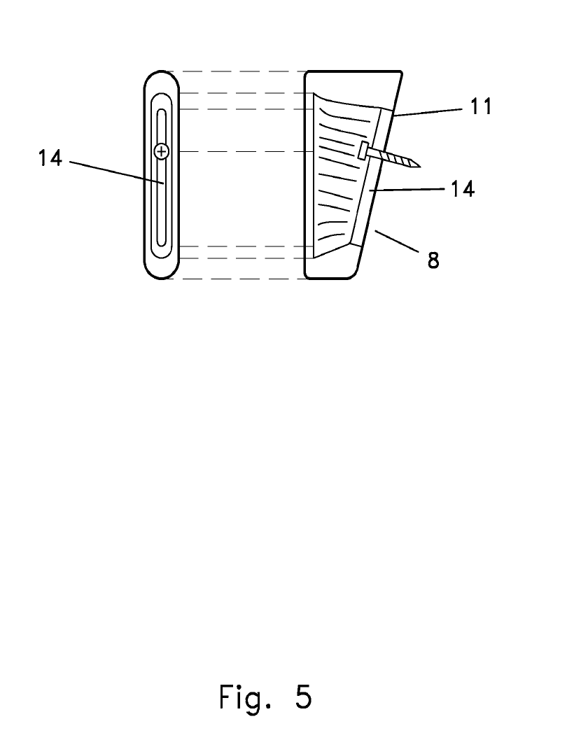

FIG. 6 shows various views of the first tubular body, the core, in an embodiment of the inventive socket adaptor.

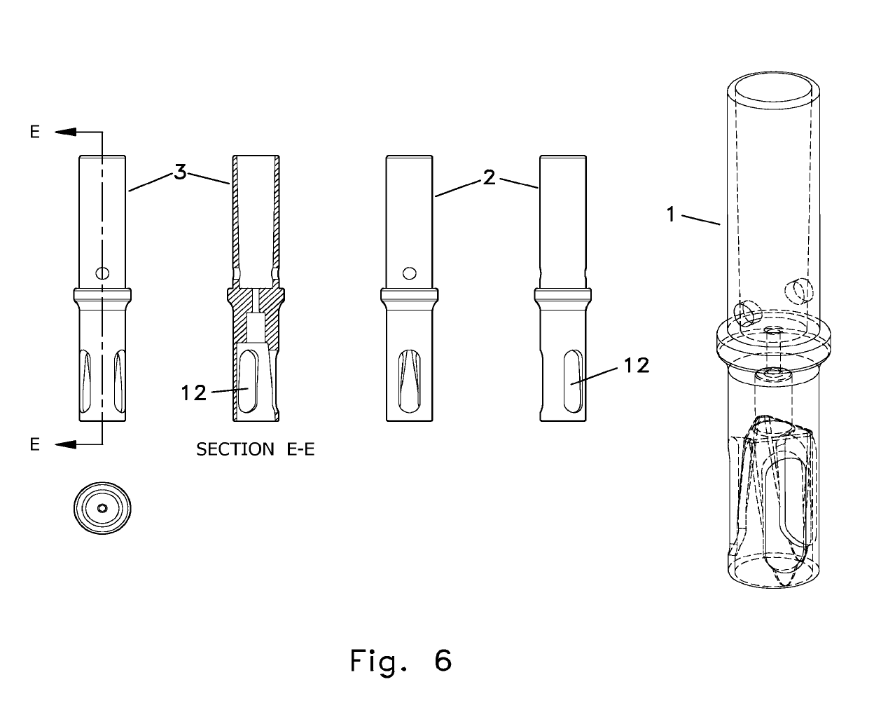

FIG. 7 shows an exploded view of a 3 wedge embodiment of the inventive socket adaptor.

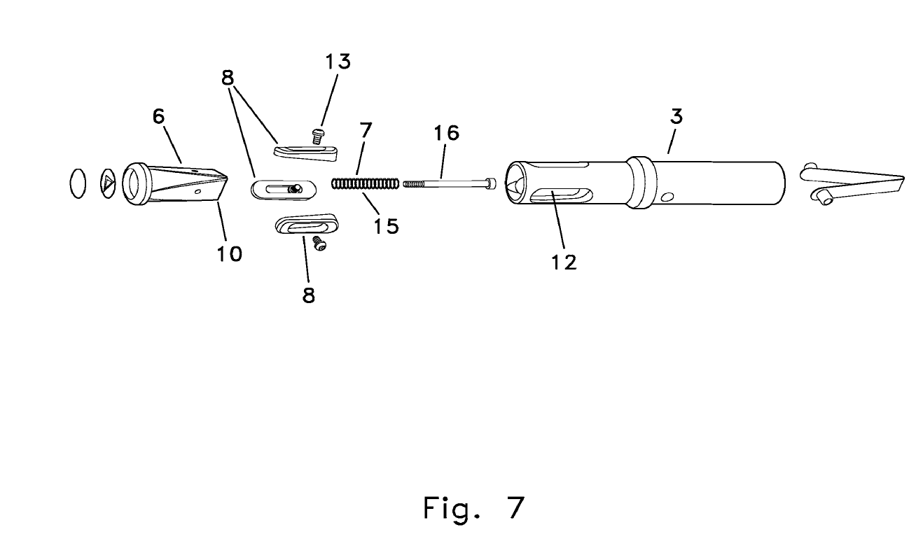

FIG. 8 shows various views of the second body, plunger, in an embodiment of the inventive socket adaptor.

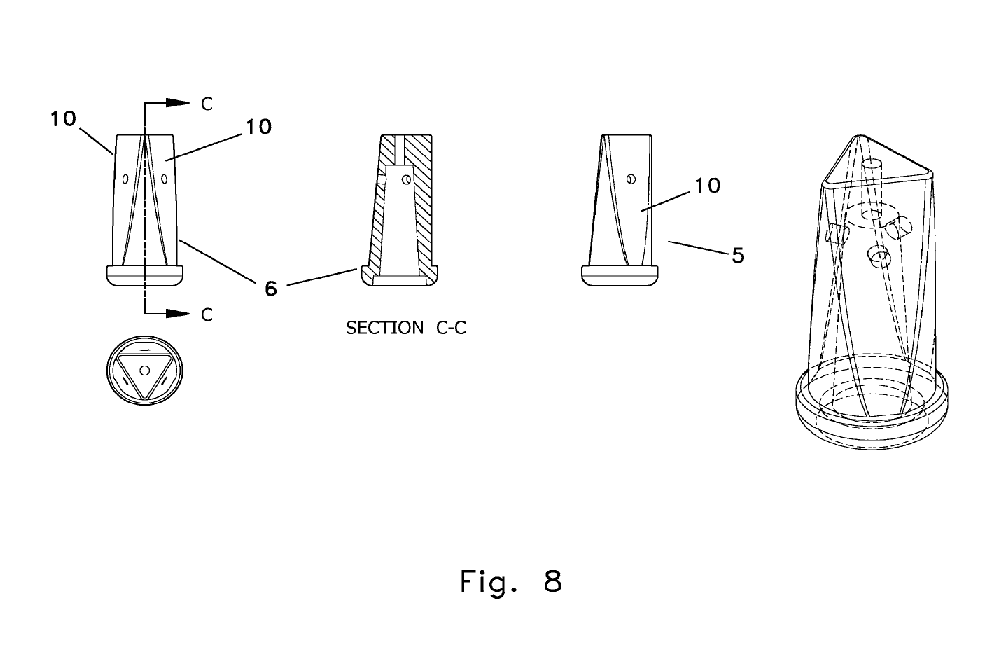

FIG. 9 shows various views of a wedge found in an embodiment of the inventive socket adaptor.

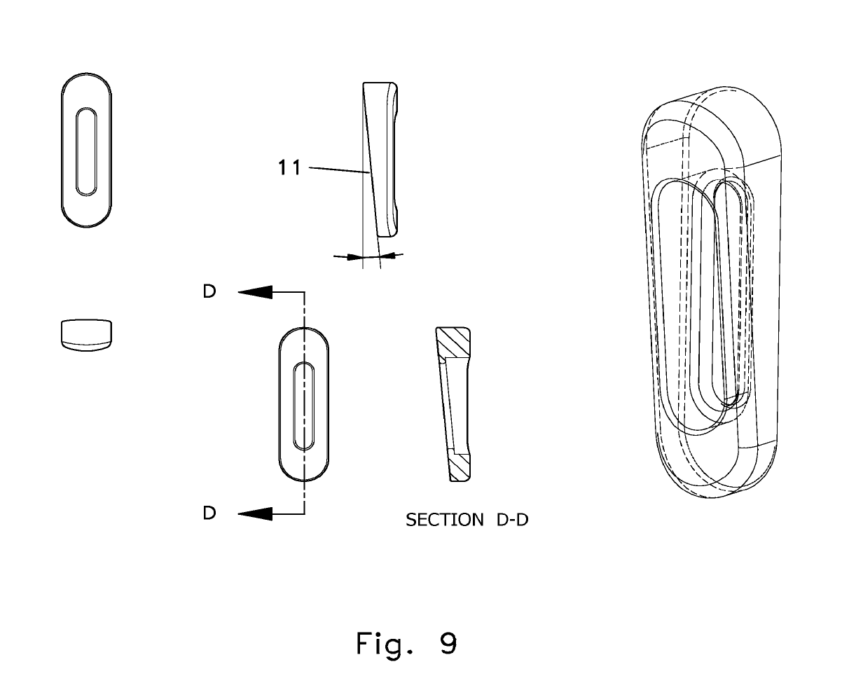

FIG. 10 shows various views of a central bar (a bolt) found in an embodiment of the inventive socket adaptor.

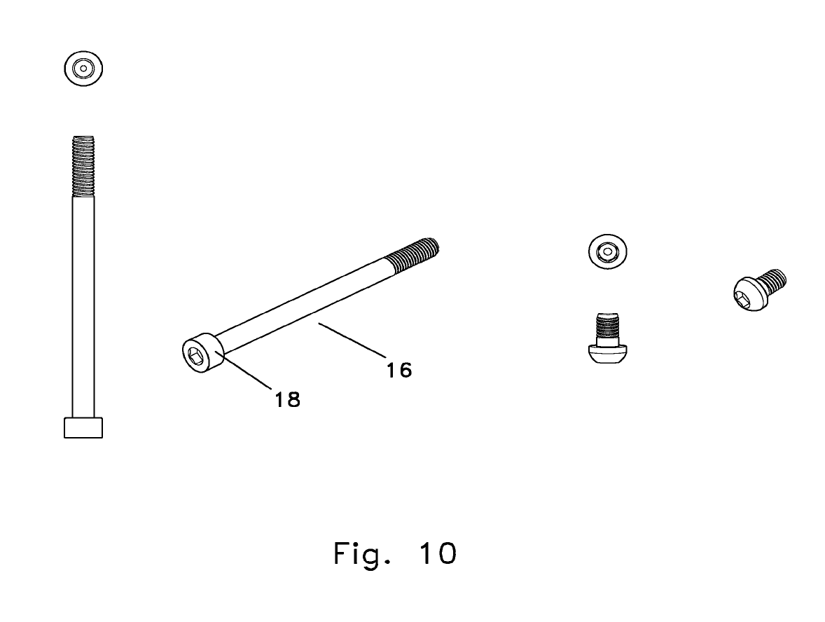

FIG. 11 shows various views of a biaser (a spring) found in an embodiment of the inventive socket adaptor.

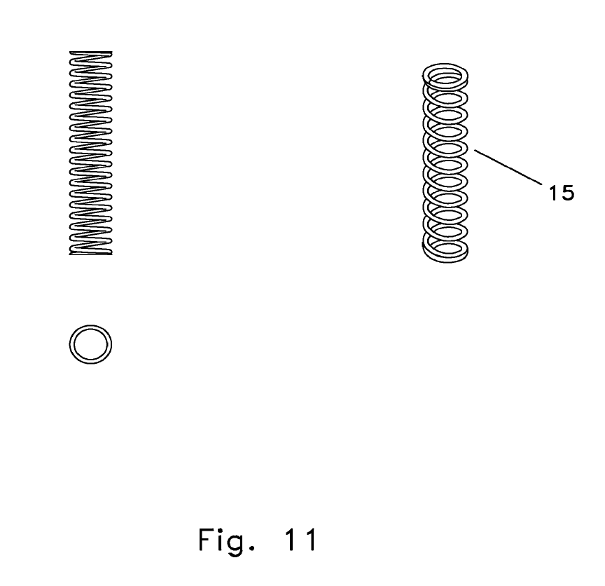

FIG. 12 shows a perspective view of an embodiment of the inventive guitar case.

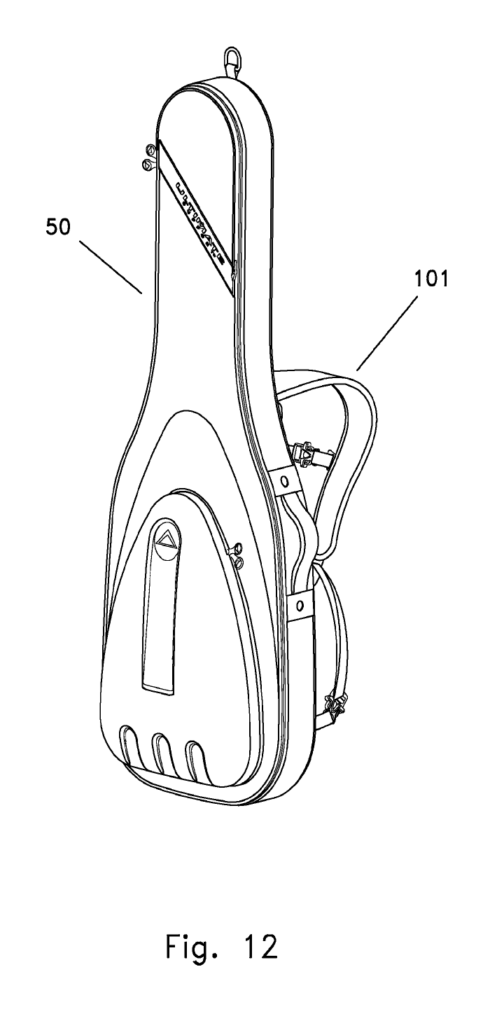

FIG. 13 shows a perspective view of an embodiment of the inventive guitar case, with pockets open.

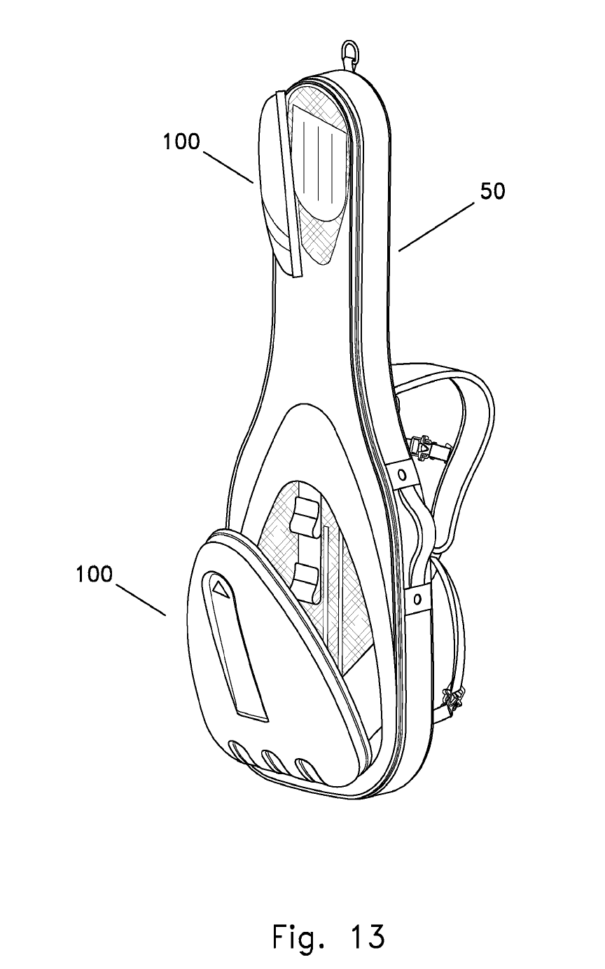

FIG. 14 shows perspective views of an embodiment of the inventive guitar case (open configuration on left; closed on right).

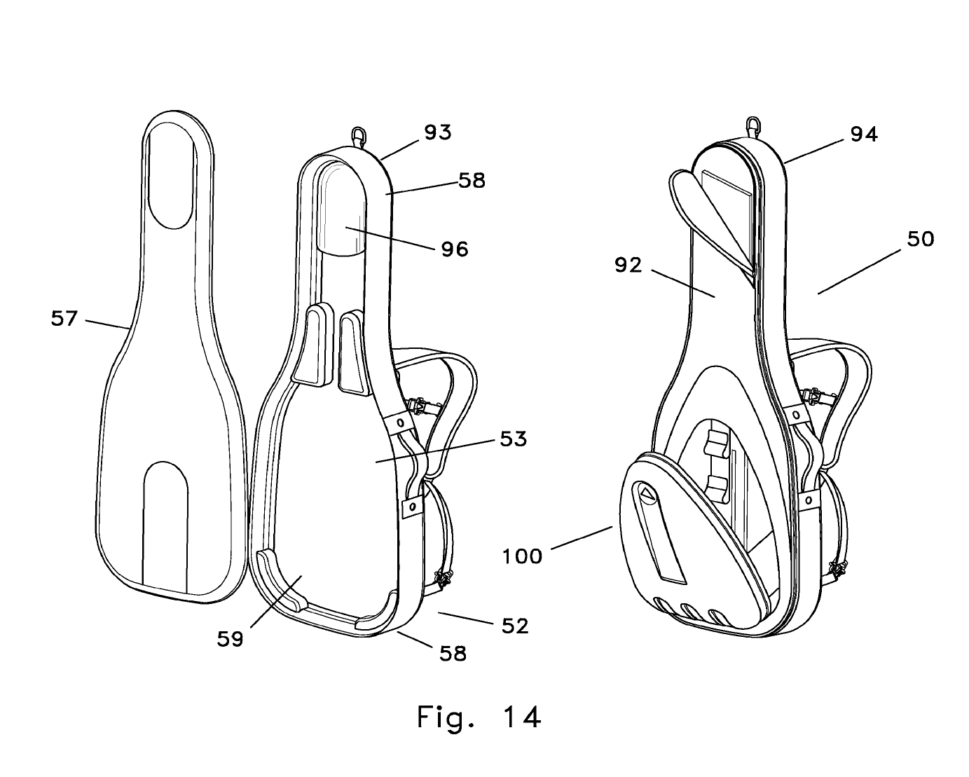

FIG. 15 shows a front view (left) and a perspective view (right) of a panel found in an embodiment of the inventive guitar case.

FIG. 16 shows guitar inserts, in their installed configuration, in an embodiment of the inventive guitar case.

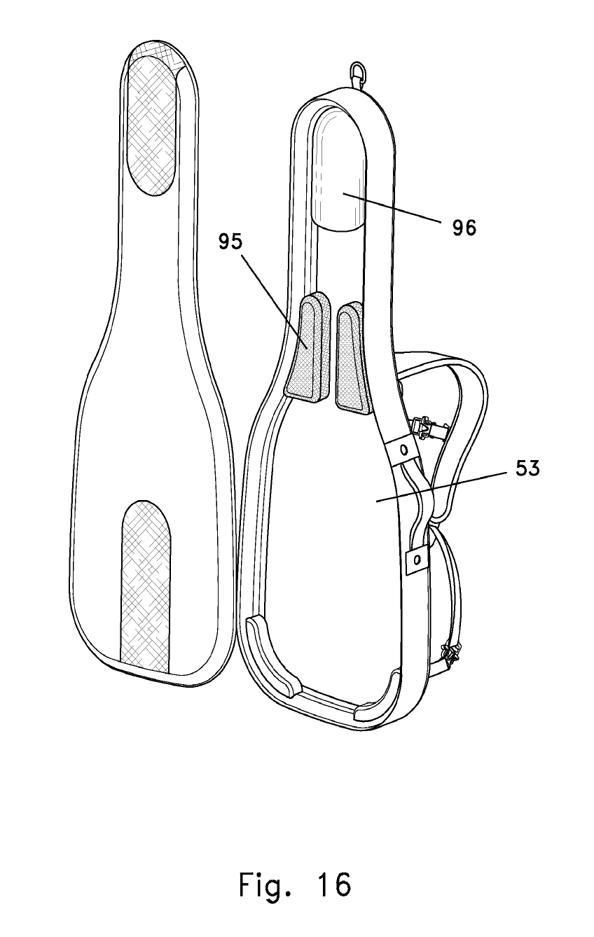

FIG. 17 shows details regarding the inserts found in an embodiment of the inventive guitar case.

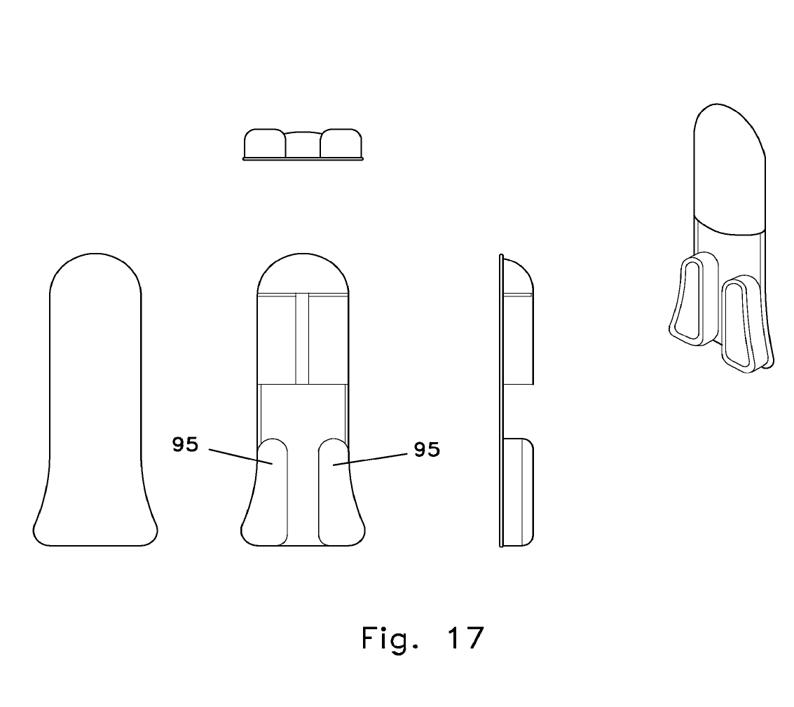

FIG. 18 shows details regarding the head stock/guitar neck inserts found in an embodiment of the inventive guitar case.

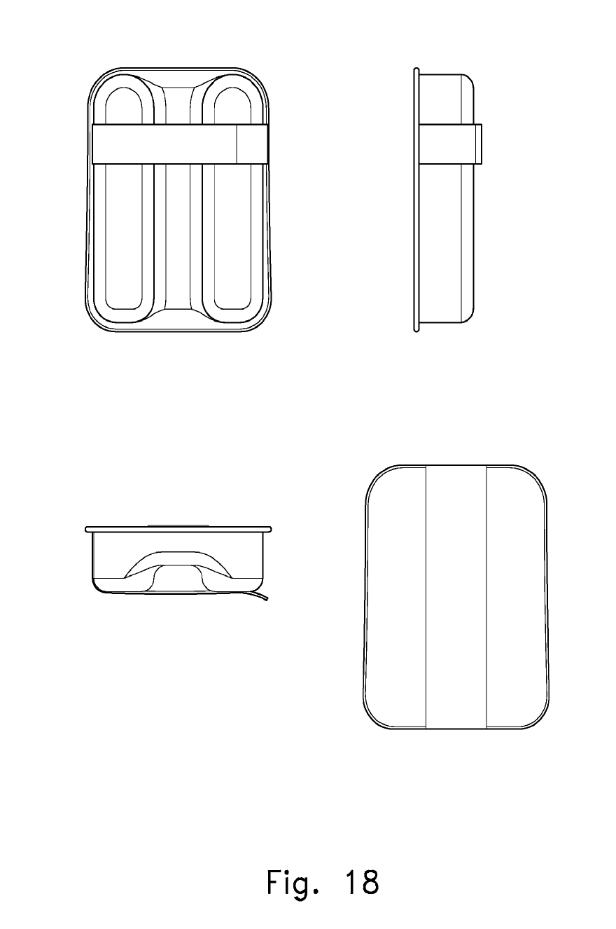

FIG. 19 shows cross-sectional views through the panel (with ribs integrated therewith), in addition to two views of guitar cases below (open on left, closed on right). The cross-section appearing at the top of the page is taken at the panel neck portion; the cross-section appearing at the middle of the page is taken at the guitar body hole panel portion. Both cross-sections are orthogonal to a centerline defined by the neck of the guitar. The panel views are at cross-sections without holes.

It is of note that any specifications shown in the figures are merely exemplary and of course do not limit the scope of the claims.

### BEST MODE FOR CARRYING OUT THE INVENTION

The present invention includes a variety of aspects, which may be combined in different ways. The following descriptions are provided to list elements and describe some of the embodiments of the present invention. These elements are listed with initial embodiments, however it should be understood that they may be combined in any manner and in any number to create additional embodiments. The variously described examples and preferred embodiments should not be construed to limit the present invention to only the explicitly described systems, techniques, and applications. Further, this description should be understood to support and encompass descriptions and claims of all the various embodiments, systems, techniques, methods, devices, and applications with any number of the disclosed elements, with each element alone, and also with any and all various permutations and combinations of all elements in this or any subsequent application.

At least one embodiment of the inventive technology may be described as a socket adapter 1 that comprises: a first tubular body 2 (e.g., a tubular core 3) defining a centerline 4; a second body 5 (e.g., a plunger 6) axially movable (i.e., movable along an axis defined by the centerline) relative to the first tubular body; a biaser 7 (a helical spring 15, as but one example) configured so as to bias the second body in a first axial direction (away from or towards, along the centerline) relative to the first tubular body; and at least two wedges 8 configured so as to move in a radially outward direction 9 (e.g., in a direction substantially orthogonal to the centerline) relative to the first tubular body when the second body moves in a second axial direction (towards or away from) relative to the first tubular body, where the second axial direction is opposite the first axial direction. It is of note that the term tube (or any of its variant forms, such as tubular), includes not only members having circular cross-sections, but also those members having different cross-sections (even those that are not circular, such as hexagonal, as but one example). It is also of note that the term secure as used herein typically implies that the secured parts are not movable relative to another, but the term connected does not imply such relative immovability.

In particular embodiments, the second body has at least two second body slide faces 10, each associated with a different one of the wedges, and the second body slide faces may be angularly sloped at an angle relative to the centerline (at any angle of from 1-20 degrees, for example, although angles outside of this range are certainly feasible; each angled surface typically has the same angle along its length, but not necessarily). In one embodiment, shown in the figures, the second body slide faces are ramped upwards as distance from the longitudinal, axial center (along the centerline) of the apparatus increases). Each of the wedges (whether there be two, three, four or more) has a wedge slide face 11 that corresponds with a different one of the at least two second body slide faces (e.g., has a matching, but oppositely disposed angle). Typically, there is one second body slide face for each wedge.

The first tubular body may have wedge shaped holes 12 (such that the shape of the holdes matches the outer shape of the wedges), one for each of the wedges, and in which the wedges may be established in the holes. The holes may axially trap the wedges therein such that axial motion of the wedges (along the centerline) relative to the first tubular body does not occur). Wedges may be connected to the second body (e.g., each to a second body slide face, loosely with screws 13 such that the wedges are axially movable relative to the second body). The screws may loosely pass through slot openings 14 of the wedges such that the screws (and the second body to which they are secured) may move relative to the slots (e.g., the screws may move along the slots). In at least one embodiment, the slot openings are angularly sloped at an angle relative to the centerline (which may be the same angle exhibited by the wedge slide faces.

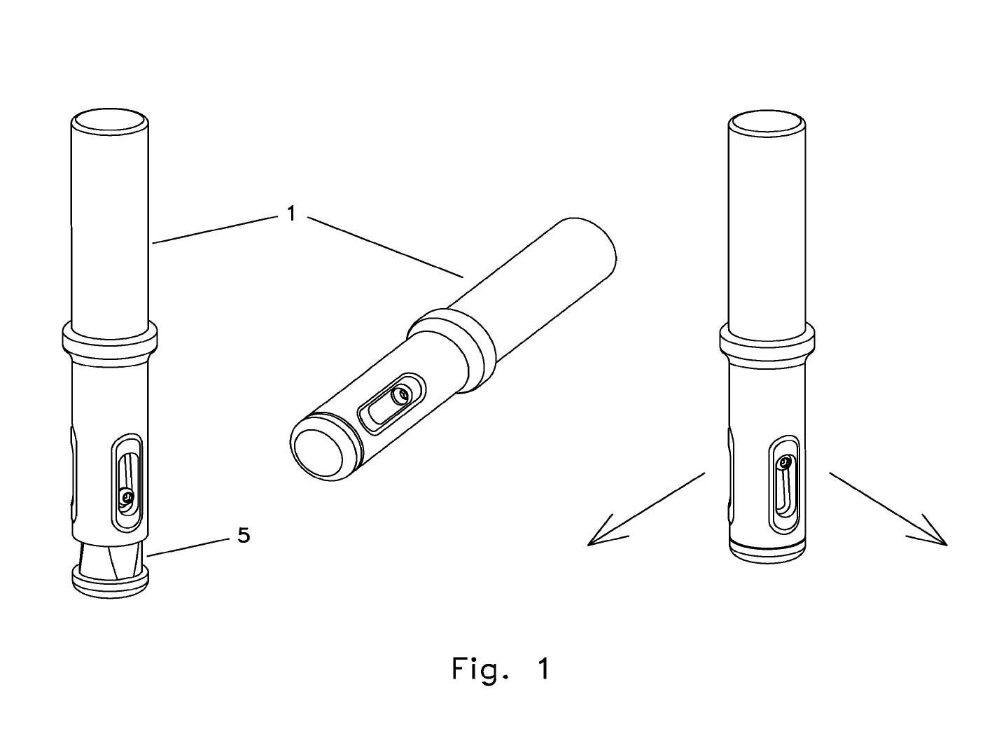

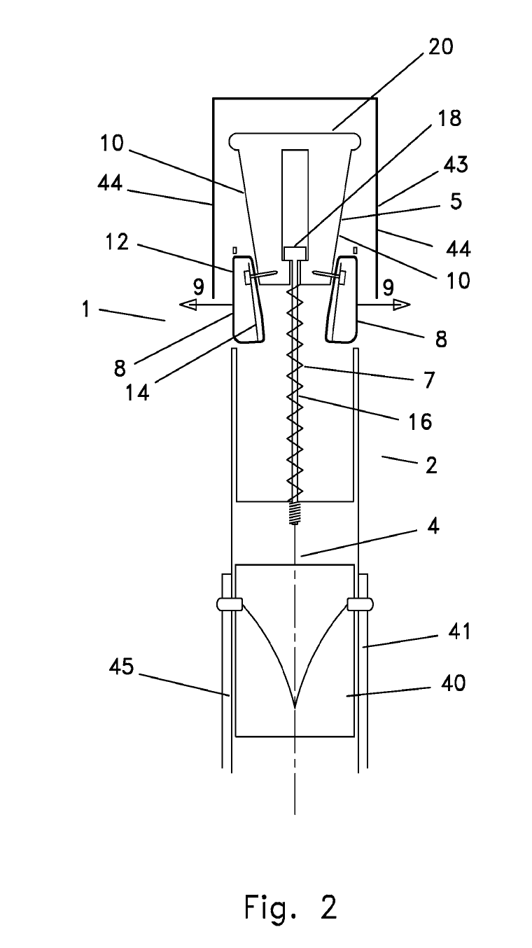

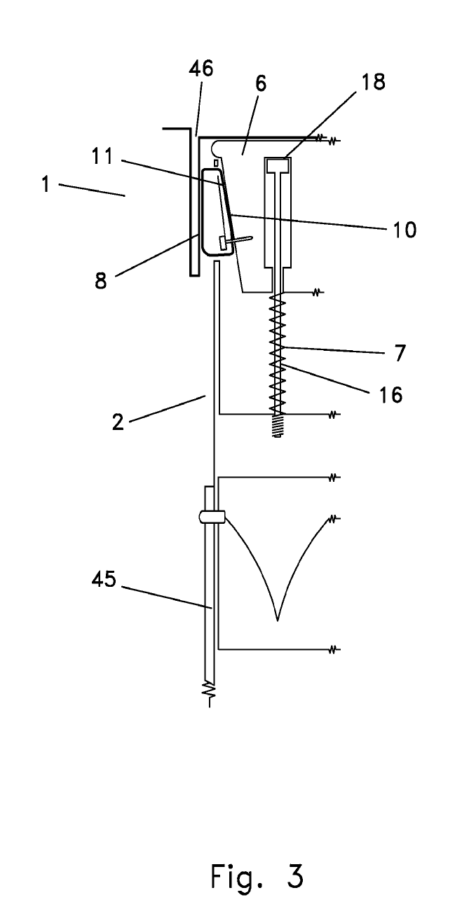

In at least one embodiment, the first axial direction (in which the second body is biased relative to the first tubular body) is axially away from the first tubular body. Such is found in embodiments where activation (i.e., outward radial movement of the wedges) occurs upon weighting (which is a broad term that includes any force application, not only that induced by gravity) of the second body moves the second body towards the first tubular body. However, other embodiments, particularly those that are activated upon weighting that moves the second body in an opposite direction (away from) the first tubular body would have biasing in a first axial direction that is axially towards the first tubular body (such design may be appropriate where a weight applying member is connected to the second body and pulls it upon weight application). In designs activated upon weighting that tends to axially move the second body away from the first tubular body, the orientation of wedge and second body slide faces, slot opening, and the biaser is as shown in FIGS. 1, 2 and 3, e.g. In those designs activated upon weighting that tends to axially move the second body towards the first tubular body, said orientations would be opposite from that shown in the figures. In either design, the bias element, as mentioned, may be a helical spring 15 that is established between (and secured to) a first tubular body part and a second body part, as shown in FIGS. 1, 2 and 3.

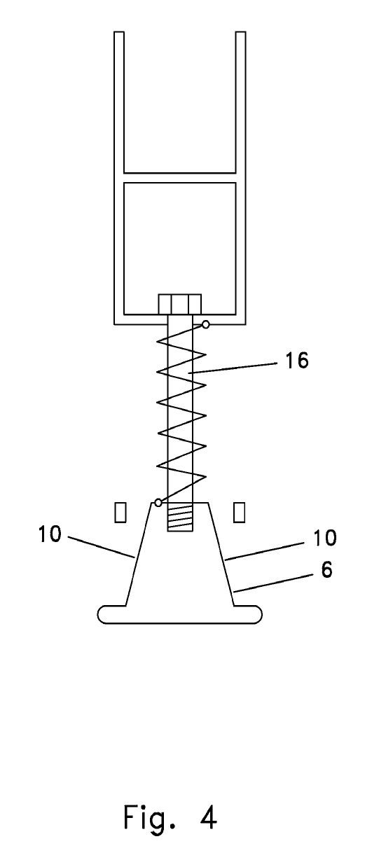

A central bar 16 may be established substantially along the centerline to provide a supplemental support, guide relative axial motion of the second body relative to the first tubular body, and/or prevent disengagement of the two bodies. In one embodiment (as shown in FIGS. 1, 2 and 3), the threaded bolt is secured to a first tubular body part (such that there is no axial motion of the first tubular body relative to the bolt) and bolt head stop connected to a second body part (such that the second body axially moves (e.g., “floats”) along the shaft of the bolt, with the bolt head 18 preventing (stopping) excessive axial motion in which the two bodies may become disengaged from one another. Of course, the central bar could just as easily be connected in the reverse manner (see FIG. 4).

A related socket adapting method may comprise the steps of: establishing a second body 5 so that it is axially movable relative to a first tubular body 2, the first tubular body defining a centerline 4; configuring a biaser 7 so as to bias the second body in a first axial direction relative to the first tubular body; and configuring at least two wedges 8 so that they move in a radially outward direction 9 relative to the first tubular body when the second body moves in a second axial direction relative to the first tubular body, where the second axial direction is opposite the first axial direction. Such steps of configuring and establishing find exemplary support in the above description and the figures (e.g., the step of establishing a second body so that it is axially movable relative to a first tubular body may involve establishing the second body at least partially in the first tubular body, and securing a central bar 16 (e.g., a bolt) to a first tubular body part and bolt head stop connecting it to a second tubular body part). The step of weighting the second end 20 of said socket adaptor may occur regardless of whether the second body is closer to the source of the weight (a monitor speaker, as but one example) than the first tubular body, or vice versa.

Another inventive method, one that addresses more directly the use of the apparatus, may be described as a self-adjusting socket adaptation method that comprises the steps of: establishing a first end 40 of a socket adaptor in substantially fixed position relative to a first tube 41 (whether with a snap fit or a corresponding ID with OD fit with one tube inside the other, as but two examples); establishing a second end 20 of the socket adaptor within a second tube 43; weighting the second end of the socket adaptor (with a gravitationally or other induced force, acting either axially away from or axially towards the socket adaptor), thereby (i.e., as a causal consequence): axially translating the second end of the socket adaptor relative to the first end (either towards or away); and radially outwardly moving wedges 8 until the wedges contact an inner surface 44 of the second tube.

In particular embodiments of this method, the step of establishing a first end of a socket adaptor in fixed position relative to a first tube may involve the step of establishing a first end of a socket adaptor in fixed position relative to a speaker stand tube 45, and the step of establishing a second end of the socket adaptor within a second tube may involve the step of establishing the second end of the socket adaptor within a tube of a speaker cabinet mounting bracket 46. In such embodiments (or indeed in certain others), the step of weighting the second end of the socket adaptor may include the step of applying the weight of a speaker to the second end of the socket adaptor.

In those embodiments with a biaser 7 (e.g., a helical spring 15, perhaps wound around a central bar 16 that the apparatus may have), the step of axially translating the second end of the socket adaptor relative to the first end may involve the step of axially translating the second end of the socket adaptor against a bias force. It is also of note that in certain embodiments, the second end is an end of a plunger of the socket adaptor.

Further, the step of radially outwardly moving wedges 8 until the wedges contact an inner surface of the second tube may comprise the step of sliding angled slide surfaces 10 of the plunger 6 against angled slide surfaces 11 of the wedges, and the step of radially outwardly moving wedges comprises the step of radially outwardly moving wedges that are connected to the plunger (and which may also be axially movable relative to the plunger). In embodiments where the first end is an end of a body core of the socket adaptor, the step of radially outwardly moving wedges may involve the step of radially outwardly moving wedges that are axially trapped within openings 12 of the body core.

It is of note that the claims are not limited to those socket adaptors having only a first tubular body and a second body (or a core and a plunger), as indeed the claims cover apparatus that may have additional components (e.g., a third body that may be analogous (but oppositely disposed) to the second body). As such, the claims cover a two plunger apparatus (one at each end of a tubular core), which may find application in those situations where automatic adjustability is desired at both ends of the apparatus, and where both tubes to be connected are able to apply a weighting force in some fashion. Of course, as one of ordinary skill in the art would appreciate, such a two plunger apparatus would have wedges (and wedge slide faces), the plunger itself, slide faces of the plunger and the biasers oriented in opposite directions where a pulling weight acted on each plunger (and thus in opposite directions). However, it can envisioned where the core (which itself may be secured to, e.g. a stationary object that is distinct from the two tubes to be connected) may have a first weight acting at one end in a first direction and a second weight acting at the other end in the same first direction; in such a case, wedges (and wedge slide faces), the plunger itself, slide faces of the plunger and the biasers of each plunger may be oriented in a similar direction. There may even be applications where the core turns such that weights applied are not co-axial. Regardless, it is the claims that govern the scope of the patent, and the claims not only do not preclude such coverage but, as is consistently with law relative to the word “comprise” (or its variant forms), are herein expressly noted to cover these alternate, and other, embodiments. It is of note that in certain embodiments, particularly those where weight is applied in a direction away from the center of the apparatus (e.g., such that such weight pulls on said plunger and is connected to said plunger), a biaser might not even be necessary. As such, this description is also deemed to include support for claims as originally filed, but without the biaser limitation.

In a related vein, applications of the inventive technology include but are not limited to connecting speaker stands with speakers. Typically, single plunger adaptors would be established such that the plunger would be atop the core and fit into the tube of the speaker mounting bracket. However, in other applications (e.g., where a speaker pole may be used to establish one speaker above a lower speaker), the orientation of the adaptor used to secure the bottom of such pole in the top of the lower speaker may be opposite (i.e., the plunger may be below the core). Of course, the orientation is governed by the application, which tube has an ID that is too large and needs to be conformed to, and which tube provides for force application through the tube, as but a few examples. Similar considerations apply to multiple plunger apparatus.

A distinct aspect of the inventive technology is a guitar case 50 reconfigurable between a closed configuration 51 and an open configuration 52, and defining an inner space 53 in which a guitar 65 may be contained, the inner space including a guitar neck space 54, a guitar body space 55 and a guitar headstock space 56, the guitar case comprising: a guitar case front portion 57, a guitar case side portion 58 and a guitar case back portion 59; and a panel 60 established as part of the guitar case front portion and having a guitar body panel hole 61, at least a portion 63 of which is positioned above the bridge 64 of the guitar 65 when the guitar is established in the guitar case and the guitar case is lying on said guitar case back portion; wherein, when the guitar case is in the closed configuration and lying on said guitar case back portion, the panel has a guitar body panel portion 66 that is above the guitar body space, a guitar neck panel portion 67 that is above the guitar neck space, and a guitar headstock panel portion 68 that is above the guitar headstock space. The guitar case may further comprise at least one first rib 70 established externally of said panel. A rib is, generally, a raised profile structural component. Typically, it has length, whether curved or straight, that is several times greater than its height or width.

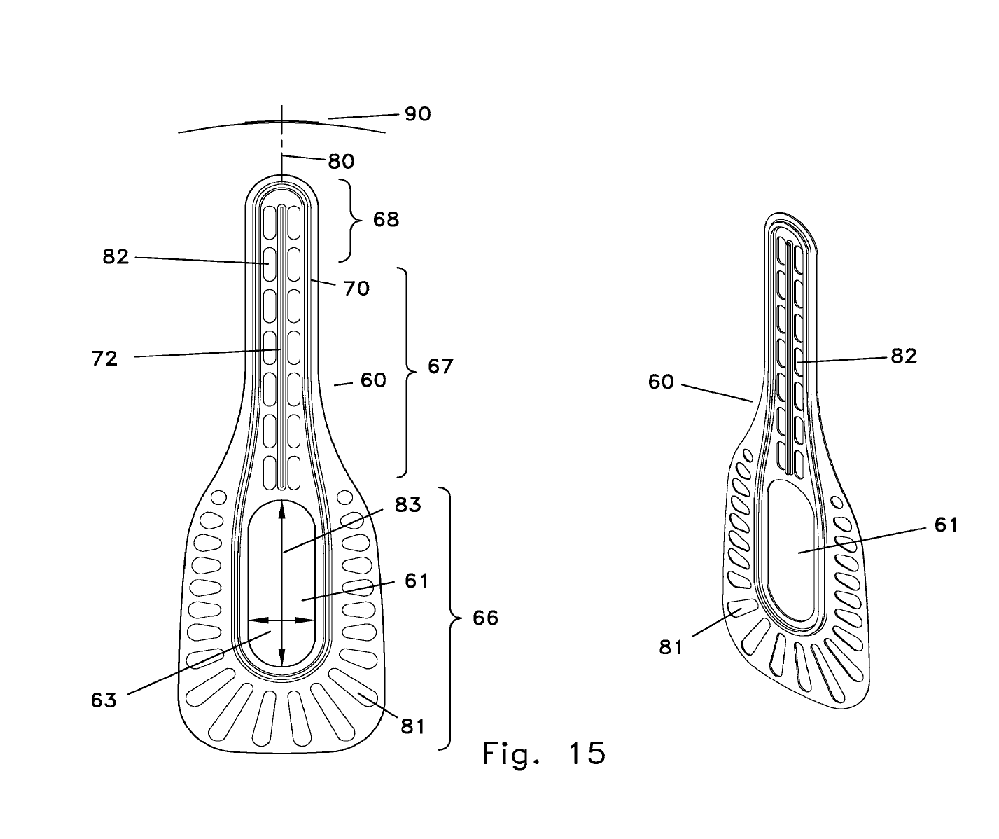

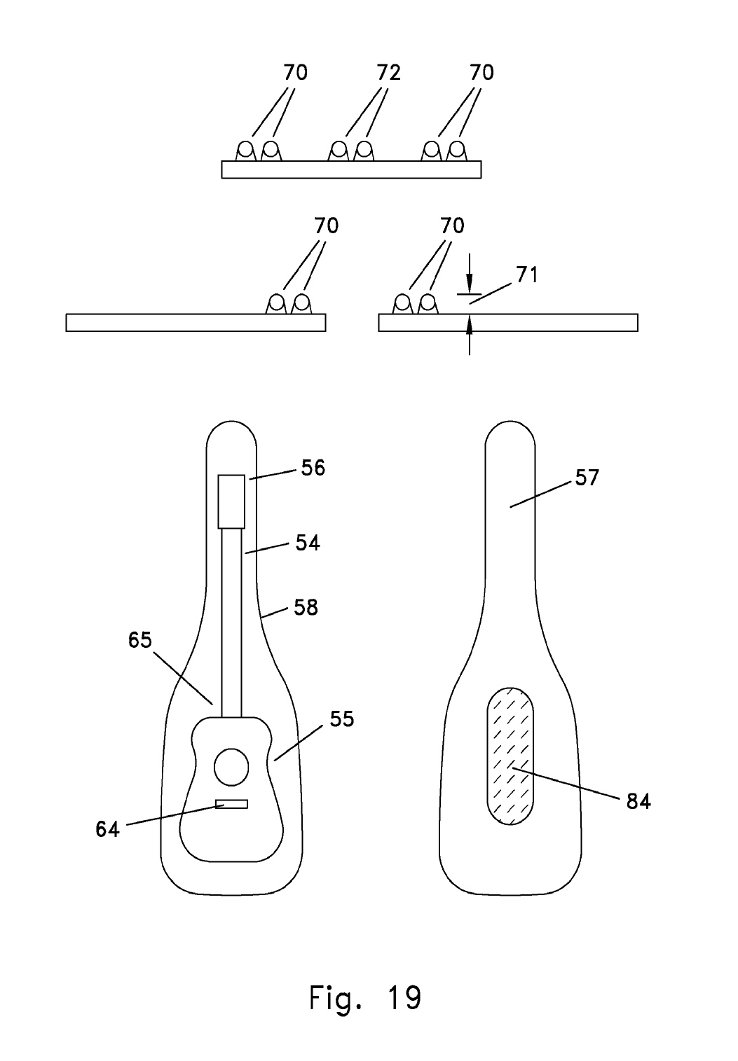

In certain embodiments, the at least one first rib is established above and along sides of the guitar neck panel portion and around at least part of the guitar body panel hole; it may be integrally adjoined to the panel (see FIG. 19), as where, e.g., the panel and the rib(s) are molded from the same material (e.g., a flexible material such as glass filled nylon). Further, at least a portion of the at least one first rib may have a height 71 of at least ⅓ inch (e.g., ½ inch); and/or an average height of at least ⅓ inch (or ½ inch). It is of note that where, e.g., a circumferential or perimetrical pattern is discontinuous (even with two or more breaks in the rib), the ribs that, if connected so as to be continuous would make such closed circumferential or perimetrical pattern, are still first ribs. The guitar case may further include at least one second rib 72 established above and substantially along the guitar neck panel portion. In certain embodiments, where the at least one first rib defines a closed shape, as shown in FIG. 15 (and even if there are discontinuities therein), the at least one second rib may be established within the closed shape. FIG. 15 shows a perimetrical pattern (around the perimeter, including around only a portion of the entire perimeter, of the guitar case or a portion thereof (e.g., around the perimeter of the guitar body portion of the case)).

It is also of note that in particular embodiments, the panel, when viewed in a cross-section that is orthogonal to a centerline 80 defined by the guitar neck panel portion, may define a panel profile having concave curvature 90. In one of many possible embodiments, the curvature may be such that the panel profile is approximately 1 inch higher (or at least 1″ higher) at its center than at its edges (ignoring any height added by any ribs). The panel, and its curvature, and the ribs each increase the structural integrity of the case, and provide impact resistance and impact force dissipation that protects the encased guitar.

The panel may further comprise a plurality of holes 81 through a border portion of the guitar body panel portion and/or a plurality of holes 82 through the guitar neck panel portion. Such holes may help to define an impact force dissipation pattern (a type of controlled flex pattern), in addition to reducing gravitational weight of the case.

The guitar body panel hole may have a length 83 aligned with a centerline defined by the guitar neck panel portion and a width that is orthogonal to the centerline; the length of the guitar body panel hole may, in particular embodiments, be at least twice a width of the guitar body panel hole. The guitar panel hole, when established over the bridge of an encased guitar, eliminates pressure on the bridge that may be observed in the absence of the hole. In order to compensate for the impact resistance lost by not having paneling above the bridge, extra foam padding 84 may be established as part of the guitar case front portion is above the guitar body panel hole.

In those embodiments where it is desired to cover the panel, the guitar case front portion may include guitar front covering portion 92 (e.g., fabric), the guitar case back portion includes a guitar back covering portion 93, and the guitar case side portion includes a guitar side covering portion. Further, certain embodiments may include inserts established in the guitar neck space, wherein at least two of the inserts are neck inserts that straddle a neck of the guitar when the guitar is in the guitar case, and at least one of the inserts is a headstock insert 96 established below a headstock of the guitar when the guitar is in the guitar case. The headstock insert may serve as a sort of pillow for the headstock; it may have a longitudinal split to accommodate a back side of the headstock. Inserts may be attached to the inside bottom of the case in a variety of manners, including but not limited to hook and loop fasteners.

Embodiments of the inventive technology may include two pockets established externally of the panel, where one of the at least one or two pockets 100 is established externally of the guitar headstock panel portion, and one of the at least two pockets is established externally of the guitar body panel portion. Further, shoulder straps 101 may be established at a back of the guitar case. It is of note that parts of the case other than the front (e.g., the sides and the back), may employ conventional support methods and/or may use one or more of the inventive aspects exhibited in the front case portion. The back case portion in particular may have a panel that in some aspects is similar to the panel found in the front, exhibiting certain inventive aspects disclosed herein.

It is of note that other broad formulations of the inventive technology may be as follows: a guitar case reconfigurable between a closed configuration and an open configuration, and defining an inner space in which a guitar may be contained, the inner space including a guitar neck space, a guitar body space and a guitar headstock space, the guitar case comprising: a guitar case front portion, a guitar case side portion and a guitar case back portion; and at least one first rib established externally of the panel. Another broad formulation is a guitar case reconfigurable between a closed configuration and an open configuration, and defining an inner space in which a guitar may be contained, the inner space including a guitar neck space, a guitar body space and a guitar headstock space, the guitar case comprising: a guitar case front portion, a guitar case side portion and a guitar case back portion; and a panel established as part of the guitar case front portion and having a guitar body panel of at least a portion is positioned above the bridge of the guitar when the guitar is established in the guitar case and the guitar case is lying on the guitar case back portion; wherein, when the guitar case is in the closed configuration and lying on said guitar case back portion, the panel has a guitar body panel portion that is above the guitar body space, a guitar neck panel portion that is above the guitar neck space, and a guitar headstock panel portion that is above the guitar headstock space.

Additional broad formulations: may include a guitar case with a panel in its front case portion that has a guitar body panel hole; a guitar case with ribs defining a perimetrical pattern; and a guitar case with ribs established as a part of the guitar case front portion that are at least ⅓″ in height and that travel from a headstock portion of the case and around the guitar body hole portion of the case (which, of course, is that portion of the guitar case that is above the guitar body hole when a guitar is encased and the guitar case is laying on its guitar case back portion).

As can be easily understood from the foregoing, the basic concepts of the present invention may be embodied in a variety of ways. It involves both connecting techniques as well as devices to accomplish the appropriate connection. In this application, the connection techniques are disclosed as part of the results shown to be achieved by the various devices described and as steps which are inherent to utilization. They are simply the natural result of utilizing the devices as intended and described. In addition, while some devices are disclosed, it should be understood that these not only accomplish certain methods but also can be varied in a number of ways. Importantly, as to all of the foregoing, all of these facets should be understood to be encompassed by this disclosure.

The discussion included in this application is intended to serve as a basic description. The reader should be aware that the specific discussion may not explicitly describe all embodiments possible; many alternatives are implicit. It also may not fully explain the generic nature of the invention and may not explicitly show how each feature or element can actually be representative of a broader function or of a great variety of alternative or equivalent elements. Again, these are implicitly included in this disclosure. Where the invention is described in device-oriented terminology, each element of the device implicitly performs a function. Apparatus claims may not only be included for the device described, but also method or process claims may be included to address the functions the invention and each element performs. Neither the description nor the terminology is intended to limit the scope of the claims that will be included in any subsequent patent application.

It should also be understood that a variety of changes may be made without departing from the essence of the invention. Such changes are also implicitly included in the description. They still fall within the scope of this invention. A broad disclosure encompassing both the explicit embodiment(s) shown, the great variety of implicit alternative embodiments, and the broad methods or processes and the like are encompassed by this disclosure and may be relied upon when drafting the claims for any subsequent patent application. It should be understood that such language changes and broader or more detailed claiming may be accomplished at a later date (such as by any required deadline) or in the event the applicant subsequently seeks a patent filing based on this filing. With this understanding, the reader should be aware that this disclosure is to be understood to support any subsequently filed patent application that may seek examination of as broad a base of claims as deemed within the applicant's right and may be designed to yield a patent covering numerous aspects of the invention both independently and as an overall system.

Further, each of the various elements of the invention and claims may also be achieved in a variety of manners. Additionally, when used or implied, an element is to be understood as encompassing individual as well as plural structures that may or may not be physically connected. This disclosure should be understood to encompass each such variation, be it a variation of an embodiment of any apparatus embodiment, a method or process embodiment, or even merely a variation of any element of these. Particularly, it should be understood that as the disclosure relates to elements of the invention, the words for each element may be expressed by equivalent apparatus terms or method terms—even if only the function or result is the same. Such equivalent, broader, or even more generic terms should be considered to be encompassed in the description of each element or action. Such terms can be substituted where desired to make explicit the implicitly broad coverage to which this invention is entitled. As but one example, it should be understood that all actions may be expressed as a means for taking that action or as an element which causes that action. Similarly, each physical element disclosed should be understood to encompass a disclosure of the action which that physical element facilitates. Regarding this last aspect, as but one example, the disclosure of a “case” should be understood to encompass disclosure of the act of “encasing”—whether explicitly discussed or not—and, conversely, were there effectively disclosure of the act of “encasing”, such a disclosure should be understood to encompass disclosure of a “case” and even a “means for encasing” Such changes and alternative terms are to be understood to be explicitly included in the description.

Any acts of law, statutes, regulations, or rules mentioned in this application for patent; or patents, publications, or other references mentioned in this application for patent are hereby incorporated by reference. Any priority case(s) claimed by this application is hereby appended and hereby incorporated by reference. In addition, as to each term used it should be understood that unless its utilization in this application is inconsistent with a broadly supporting interpretation, common dictionary definitions should be understood as incorporated for each term and all definitions, alternative terms, and synonyms such as contained in the Random House Webster's Unabridged Dictionary, second edition are hereby incorporated by reference. Finally, all references listed in the list of references or other information statement filed with the application are hereby appended and hereby incorporated by reference, however, as to each of the above, to the extent that such information or statements incorporated by reference might be considered inconsistent with the patenting of this/these invention(s) such statements are expressly not to be considered as made by the applicant(s).

### I. U.S. Patent Documents

| DOCUMENT NO. | PUB'N | |
|---|---|---|
| & KIND CODE (if | DATE | PATENTEE OR |
| known) | mm-dd-yyyy | APPLICANT NAME |
| D257987 | 01/20/1981 | Schoenig |
| D264852 | 06/08/1982 | Scheonig |
| D288755 | 03/17/1987 | Schoenig |
| D289952 | 05/26/1987 | Kido |
| D290355 | 60/16/1987 | Nagele |
| D304270 | 10/31/1989 | Goldman |
| D306943 | 04/03/1990 | Hodge et al. |
| D320034 | 09/17/1991 | Brooks et al. |
| D321293 | 11/05/1991 | Kucsak |
| D364516 | 11/28/1995 | Helenowski |
| D414962 | 10/12/1999 | Welsh et al. |
| D468133 | 01/07/2003 | Lauts |
| D470336 | 02/18/2003 | Malizia |
| D475555 | 06/10/2003 | Lauts |
| D409594 | 05/11/1999 | Lepack |
| D409020 | 05/04/1999 | Hardin |
| D370575 | 06/11/1996 | Lechleiter et al. |
| D336099 | 06/01/1993 | Scheonig |
| D323081 | 01/14/1992 | Schaffer |
| D268458 | 04/05/1983 | Schoenig |
| D018940 | 02/26/1889 | Jackson |
| 0,688,623 | 12/10/1901 | Forry |
| D335889 | 05/25/1993 | Gibran |
| D137960 | 05/23/1944 | Hagar |
| D268458 | 04/05/1983 | Schoenig |
| 3,338,539 | 08/29/1967 | Foster |
| 4,321,874 | 04/30/1982 | Cenna |
| 4,445,415 | 05/01/1984 | Izquierdo |
| 4,669,691 | 06/02/1987 | Solomon |
| 4,763,865 | 08/16/1988 | Danner |
| 4,770,380 | 09/13/1988 | Eason et al. |
| 4,917,341 | 4/17/19900 | Pirchio |
| 4,988,064 | 01/29/1991 | Hoshino |
| 4,988,150 | 01/29/1991 | Lindow et al. |
| 5,112,020 | 05/12/1992 | Ginsberg |
| 5,165,635 | 11/24/1992 | Hoshino |
| 5,188,321 | 02/23/1993 | Hirschenson et al. |
| 5,199,930 | 04/06/1993 | Weber |
| 5,208,736 | 05/04/1993 | Crooks et al. |
| 5,251,925 | 10/12/1993 | Haley, Sr. |
| 5,301,910 | 04/12/1994 | Lang et al. |
| 5,312,076 | 05/17/1994 | Rogov |
| 5,322,250 | 06/21/1994 | Wilhite Jr. |
| 5,358,204 | 10/25/1994 | Terada |
| 5,390,764 | 02/21/1995 | Kerber |
| 5,392,476 | 02/28/1995 | Williams |
| 5,395,088 | 03/07/1995 | Ginsberg |
| 5,476,953 | 11/21/1995 | Malizia |
| 5,509,629 | 04/23/1996 | Sassmannshausen et al. |
| 5,565,889 | 10/15/1996 | Crooks et al. |
| 5,572,237 | 11/05/1996 | Crooks et al. |
| 5,603,480 | 02/18/1997 | Chen |
| 5,732,928 | 03/31/1998 | Chang |
| 5,894,406 | 04/13/1999 | Blend et al. |
| 5,996,814 | 12/07/1999 | Workman et al. |
| 6,045,179 | 04/04/2000 | Harrison |
| 6,375,135 | 04/23/2002 | Eason et al. |
| 6,695,268 | 2/24/2004 | Hsieh |
| 6,563,035 | 5/13/2003 | Hsieh |
| D580262 | 11/11/2008 | Eason, et al. |
| 6,814,332 | 09/11/2004 | Eason |
| D576870 | 09/16/2008 | Eason, et al. |
| 6,789,772 | 09/14/2001 | Eason |
| 6,343,802 | 06/12/1998 | Workman, et al. |
| 6,283,421 | 09/04/2001 | Eason, et al. |
| 5,857,649 | 01/12/1999 | Eason |
| 7,412,069 | 08/12/2008 | Workman, et al. |
| D506219 | 06/14/2005 | Eason |
| D493363 | 07/27/2004 | Eason |
| D450339 | 11/13/2001 | Eason |
| D435365 | 12/26/2000 | Eason, et al. |
| D421447 | 11/13/2001 | Eason |
| D416464 | 11/16/1999 | Eason |
| D400735 | 11/10/1998 | House, et al. |
| D375639 | 11/19/1996 | House, et al. |
| D364281 | 11/21/1995 | Eason |
| D336099 | 06/01/1993 | Schoenig |
| D329342 | 09/15/1992 | Schoenig |
| D326969 | 06/16/1992 | Eason, et al. |
| 6,789,772 | 09/14/2004 | Eason |
| 5,857,649 | 01/12/1999 | Eason |
| 5,048,789 | 07/09/1991 | Eason, et al. |
| 5,029,796 | 07/09/1991 | Schoenig |
| 4,671,479 | 08/26/2003 | Malizia |
| 3,711,054 | 01/16/1973 | Bauer |
| 3,788,587 | 01/29/1974 | Stemmler |
| 3,989,211 | 11/02/1976 | Gundlach |
| 4,108,423 | 08/22/1978 | Skubal |
| 4,697,773 | 10/06/1987 | Juamann, et al. |
| 4,763,864 | 08/16/1988 | Healy |
| 4,844,392 | 07/04/1989 | Bauer, et al. |
| 5,078,351 | 01/07/1992 | Gualtieri |
| 5,531,413 | 07/02/1996 | Wolf, et al. |
| 5,765,804 | 06/16/1998 | Stumpf, et al. |
| 6,073,903 | 06/13/2000 | Lindsay |
| 6,375,135 | 04/23/2002 | Eason, et al. |
| Des. 421,447 | 03/07/2000 | Eason, et al. |
| 20020109051 | 08/15/2002 | Kitagawa et al. |
| 20020100852 | 08/01/2002 | Eason et al. |
| 20040144233 | 07/29/2004 | Hsieh |
| 20080229901 | 09/25/2008 | Eason, et al. |
| 20050035247 | 02/17/2005 | Roberts, et al. |
| 20080247810 | 10/09/2008 | Eason |
| 20080229901 | 09/25/2008 | Eason |

### II. Foreign Patent Documents

| | PUB'N | |
|---|---|---|
| Foreign Patent | DATE | PATENTEE OR |
| Document | mm-dd-yyyy | APPLICANT NAME |
| WO2006073383 | 07/13/2006 | Swift Distribution Inc. |
| WO20050067541 | 07/28/2005 | Swift Distribution Inc. et al. |
| WO20050070132 | 04/08/2005 | Swift Distribution Inc. |
| CA122838 | 11/13/2008 | Eason, et al. |
| CN200730329518 | 11/25/2009 | Eason, et al. |
| DE11-2004-000-142 | 12/29/2005 | Eason |
| UK2412850 | 07/11/2007 | Eason |
| UK2429494 | 08/29/2007 | Eason |
| CA122836 | 09/17/2008 | Eason, et al. |
| CN200730329517.6 | 12/10/2008 | Eason, et al. |
| CA122837 | 06/17/2009 | Eason, et al. |
| CN200730329519.5 | 04/29/2009 | Eason, et al. |
| CA2594892 | 07/28/2005 | Eason, et al. |
| EP1714272 | 10/25/2006 | Eason, et al. |
| JP2007-525627 | 09/06/2007 | Eason, et al. |
| CA126835 | 10/20/2009 | Belitz, et al. |
| WO2004066667 | 08/05/2004 | Ultimate Support Systems, Inc. |
| WO2005070123 | 08/04/2005 | Ultimate Support Systems, Inc. |
| WO2005070184 | 08/05/2004 | Ultimate Support Systems, Inc. |
| WO2009091929 | 07/23/2009 | Ultimate Support Systems, Inc. |
| WO2004065841 | 08/05/2004 | Ultimate Support Systems, Inc. |
| WO2008134653 | 11/06/2008 | Ultimate Support Systems, Inc. |

### III. Non-Patent Literature Documents

Konig & Meyer Spider Keyboard Stand, audioMIDI.com Dec. 28, 2004
Ultimate Support Systems, Inc. 1993 Product Catalog (Music Stand Edition)
Ultimate Support Systems, Inc. 1994 Product Catalog (Music Stand Edition)
Ultimate Support Systems, Inc. 1996 Product Catalog (Music Stand Edition)
Ultimate Support Systems, Inc. 1998 Product Catalog (Music Stand Edition)
Ultimate Support Systems, Inc. 1999 Product Catalog (Music Stand Edition)
Ultimate Support Systems, Inc. 2000 Product Catalog (Music Stand Edition)
Ultimate Support Systems, Inc. 2001 Product Catalog (Music Stand Edition)
Ultimate Support Systems, Inc. 2002 Product Catalog (Music Stand Edition)
Ultimate Support Systems, Inc. 2003 Product Catalog (Music Stand Edition)
Ultimate Support Systems, Inc. 2004 Product Catalog (Bicycle Stand
Edition)
Ultimate Support Systems, Inc. 2004 Product Catalog (Music Stand Edition)
Ultimate Support Systems, Inc. 2005 Product Catalog (Bicycle Stand
Edition)
Ultimate Support Systems, Inc. 2005 Product Catalog (Music Stand Edition)
Ultimate Support Systems, Inc. 2008 Product Catalog (Music Stand Edition)
Pending U.S. patent application No. 29/286,257; filed Apr. 27, 2007
Pending U.S. patent application No. 29/294,538; filed Jan. 15, 2008
Pending U.S. patent application No. 61/144,649; filed Jan. 14, 2009
Pending U.S. patent application No. 12/597,905; filed Oct. 27, 2009
Pending U.S. patent application No. 29/230,680; filed May 24, 2005

Thus, the applicant(s) should be understood to have support to claim and make a statement of invention at least: i) each of the adaptor and case devices as herein disclosed and described, ii) the related methods disclosed and described, iii) similar, equivalent, and even implicit variations of each of these devices and methods, iv) those alternative designs which accomplish each of the functions shown as are disclosed and described, v) those alternative designs and methods which accomplish each of the functions shown as are implicit to accomplish that which is disclosed and described, vi) each feature, component, and step shown as separate and independent inventions, vii) the applications enhanced by the various systems or components disclosed, viii) the resulting products produced by such systems or components, ix) each system, method, and element shown or described as now applied to any specific field or devices mentioned, x) methods and apparatuses substantially as described hereinbefore and with reference to any of the accompanying examples, xi) the various combinations and permutations of each of the elements disclosed, xii) each potentially dependent claim or concept as a dependency on each and every one of the independent claims or concepts presented, and xiii) all inventions described herein.

With regard to claims whether now or later presented for examination, it should be understood that for practical reasons and so as to avoid great expansion of the examination burden, the applicant may at any time present only initial claims or perhaps only initial claims with only initial dependencies. The office and any third persons interested in potential scope of this or subsequent applications should understand that broader claims may be presented at a later date in this case, in a case claiming the benefit of this case, or in any continuation in spite of any preliminary amendments, other amendments, claim language, or arguments presented, thus throughout the pendency of any case there is no intention to disclaim or surrender any potential subject matter. It should be understood that if or when broader claims are presented, such may require that any relevant prior art that may have been considered at any prior time may need to be re-visited since it is possible that to the extent any amendments, claim language, or arguments presented in this or any subsequent application are considered as made to avoid such prior art, such reasons may be eliminated by later presented claims or the like. Both the examiner and any person otherwise interested in existing or later potential coverage, or considering if there has at any time been any possibility of an indication of disclaimer or surrender of potential coverage, should be aware that no such surrender or disclaimer is ever intended or ever exists in this or any subsequent application. Limitations such as arose in Hakim v. Cannon Avent Group, PLC, 479 F.3d 1313 (Fed. Cir 2007), or the like are expressly not intended in this or any subsequent related matter. In addition, support should be understood to exist to the degree required under new matter laws—including but not limited to European Patent Convention Article 123(2) and United States Patent Law 35 USC 132 or other such laws—to permit the addition of any of the various dependencies or other elements presented under one independent claim or concept as dependencies or elements under any other independent claim or concept. In drafting any claims at any time whether in this application or in any subsequent application, it should also be understood that the applicant has intended to capture as full and broad a scope of coverage as legally available. To the extent that insubstantial substitutes are made, to the extent that the applicant did not in fact draft any claim so as to literally encompass any particular embodiment, and to the extent otherwise applicable, the applicant should not be understood to have in any way intended to or actually relinquished such coverage as the applicant simply may not have been able to anticipate all eventualities; one skilled in the art, should not be reasonably expected to have drafted a claim that would have literally encompassed such alternative embodiments.

Further, if or when used, the use of the transitional phrase “comprising” is used to maintain the “open-end” claims herein, according to traditional claim interpretation. Thus, unless the context requires otherwise, it should be understood that the term “comprise” or variations such as “comprises” or “comprising”, are intended to imply the inclusion of a stated element or step or group of elements or steps but not the exclusion of any other element or step or group of elements or steps. Such terms should be interpreted in their most expansive form so as to afford the applicant the broadest coverage legally permissible. The use of the phrase, “or any other claim” is used to provide support for any claim to be dependent on any other claim, such as another dependent claim, another independent claim, a previously listed claim, a subsequently listed claim, and the like. As one clarifying example, if a claim were dependent “on claim 20 or any other claim” or the like, it could be re-drafted as dependent on claim 1, claim 15, or even claim 715 (if such were to exist) if desired and still fall with the disclosure. It should be understood that this phrase also provides support for any combination of elements in the claims and even incorporates any desired proper antecedent basis for certain claim combinations such as with combinations of method, apparatus, process, and the like claims.

Finally, any claims set forth at any time are hereby incorporated by reference as part of this description of the invention, and the applicant expressly reserves the right to use all of or a portion of such incorporated content of such claims as additional description to support any of or all of the claims or any element or component thereof, and the applicant further expressly reserves the right to move any portion of or all of the incorporated content of such claims or any element or component thereof from the description into the claims or vice-versa as necessary to define the matter for which protection is sought by this application or by any subsequent continuation, division, or continuation-in-part application thereof, or to obtain any benefit of, reduction in fees pursuant to, or to comply with the patent laws, rules, or regulations of any country or treaty, and such content incorporated by reference shall survive during the entire pendency of this application including any subsequent continuation, division, or continuation-in-part application thereof or any reissue or extension thereon. It is of note that the claims following are intended to also include: An apparatus/method substantially as herein described with reference to any one or more of the Figures and Description; in addition to a process according to any preceding claims and further comprising any of the steps as shown in any Figures, separately, in any combination or permutation.

1. A socket adapter comprising:
a first tubular body defining a centerline;
a second body axially movable relative to said first tubular body;
a biaser configured so as to bias said second body in a first axial direction relative to said first tubular body; and
at least two wedges configured so as to move in a radially outward direction relative to said first tubular body when said second body moves in a second axial direction relative to said first tubular body,
wherein said second axial direction is opposite said first axial direction.

2. A socket adapter as described in claim 1 wherein said second body comprises at least two second body slide faces, each associated with a different one of said wedges, said slide faces being angularly sloped at an angle relative to said centerline.

3. A socket adapter as described in claim 2 wherein each of said at least two wedges comprises a wedge slide face that corresponds with a different one of said at least two second body slide faces.

4. A socket adapter as described in claim 1 wherein said at least two wedges comprises at least 3 wedges.

5. A socket adapter as described in claim 1 wherein said first tubular body comprises wedge shaped holes, one for each of said wedges.

6. A socket adapter as described in claim 5 wherein said at least two wedges are established in said holes and connected to said second body.

7. A socket adapter as described in claim 6 wherein the shape of said holes matches the outer shape of said wedges.

8. A socket adapter as described in claim 7 wherein said holes axially trap said wedges therein.

9. A socket adapter as described in claim 6 wherein said at least two wedges are connected to second body slide faces.

10. A socket adapter as described in claim 6 wherein said at least two wedges are connected to said second body with screws such that said wedges are axially movable relative to said second body.

11. A socket adapter as described in claim 10 wherein said at least two wedges comprise slot openings and said screws pass through slot openings.

12. A socket adapter as described in claim 11 wherein said slot openings are angularly sloped at an angle relative to said centerline.

13. A socket adapter as described in claim 1 wherein said first axial direction is axially away from said first tubular body.

14. A socket adapter as described in claim 13 wherein said second axial direction is axially toward said first tubular body.

15. A socket adapter as described in claim 1 wherein said biaser comprises a helical spring established between a first tubular body part and a second body part.

16. A socket adapter as described in claim 1 further comprises a central bar established substantially along said centerline.

17. A socket adapter as described in claim 16 wherein said central bar comprises a threaded bolt.

18. A socket adapter as described in claim 17 wherein said threaded bolt is secured to a first tubular body part and bolt head stop connected to a second body part.

19. A socket adapting method comprising the steps of:
establishing a second body so that it is axially movable relative to a first tubular body, said first tubular body defining a centerline;
configuring a biaser so as to bias said second body in a first axial direction relative to said first tubular body; and
configuring at least two wedges so that they move in a radially outward direction relative to said first tubular body when said second body moves in a second axial direction relative to said first tubular body, where said second axial direction is opposite said first axial direction.

20-36. (canceled)

37. A self-adjusting socket adaptation method comprising the steps of:
establishing a first end of a socket adaptor in substantially fixed position relative to a first tube;
establishing a second end of said socket adaptor within a second tube;
weighting said second end of said socket adaptor, thereby:
axially translating said second end of said socket adaptor relative to said first end; and
radially outwardly moving wedges until said wedges contact an inner surface of said second tube.

38. A self-adjusting socket adaptation method as described in claim 37 wherein said step of establishing a first end of a socket adaptor in fixed position relative to a first tube comprises the step of establishing a first end of a socket adaptor in fixed position relative to a speaker stand tube.

39. A self-adjusting socket adaptation method as described in claim 37 wherein said step of establishing a second end of said socket adaptor within a second tube comprises the step of establishing the second end of said socket adaptor within a tube of a speaker cabinet mounting bracket.

40. A self-adjusting socket adaptation method as described in claim 37 wherein said step of weighting said second end of said socket adaptor comprises the step of applying the weight of a speaker to said second end of said socket adaptor.

41. A self-adjusting socket adaptation method as described in claim 37 wherein said step of axially translating said second end of said socket adaptor relative to said first end comprises the step of axially translating said second end of said socket adaptor against a bias force.

42. A self-adjusting socket adaptation method as described in claim 37 wherein said second end is an end of a plunger of said socket adaptor.

43. A self-adjusting socket adaptation method as described in claim 42 wherein said step of radially outwardly moving wedges until said wedges contact an inner surface of said second tube comprises the step of sliding angled surfaces of said plunger against angled surfaces of said wedges.

44. A self-adjusting socket adaptation method as described in claim 42 wherein said step of radially outwardly moving wedges comprises the step of radially outwardly moving wedges that are connected to said plunger.

45. A self-adjusting socket adaptation method as described in claim 44 wherein said step of radially outwardly moving wedges that are connected to said plunger comprises the step of radially outwardly moving wedges that are axially movable relative to said plunger.

46. A self-adjusting socket adaptation method as described in claim 37 wherein said first end is an end of a body core of said socket adaptor.

47. A self-adjusting socket adaptation method as described in claim 46 wherein said step of radially outwardly moving wedges comprises the step of radially outwardly moving wedges that are axially trapped within openings of said body core.

48-75. (canceled)
